(19) United States
(12) Patent Application Publication
(10) Pub. No.: US 2020/0095807 A1
(43) Pub. Date: Mar. 26, 2020

(54) Zipper Lock Device for Bags

(71) Applicant: JBS Inc., Nishinari-ku, Osaka (JP)

(72) Inventor: Tadao YASUDA, Nishinari-ku (JP)

(21) Appl. No.: 16/500,839

(22) PCT Filed: Mar. 28, 2018
(86) PCT No.: PCT/JP2018/012782

§ 371 Date: Oct. 4, 2019

(30) Foreign Application Priority Data
Apr. 5, 2017 (JP) 2017-075484

(51) Int. Cl. E05B 65/52; A45C 13/10; E05B 47/00; E05B 45/06; G07C 9/00

(52) U.S. Cl. CPC E05B 65/5215; A45C 13/103; G07C 9/00182; E05B 45/06; E05B 47/0001

(57) ABSTRACT

A zipper lock device for bags is provided, which has a function for locking and unlocking the slider of the zipper without exposing the lock mechanism to the outer appearance of the bags, aiming at improving the design and convenience. The zipper lock device is for locking a slider of a zipper provided on an opening edge of the bags, and comprises: a protrusion provided on a back side of the slider; and a lock unit provided inside the bags at a forward position of a closing direction of the zipper, for receiving the protrusion so as to lock the slider. The lock unit comprises: a lock mechanism for locking the slider by engaging with the protrusion; a drive unit for operating the lock mechanism; and an electronic circuit for receiving a wireless signal from outside of the bags and controlling the operation of the drive unit.

### TECHNICAL FIELD

The present invention relates to a zipper lock device for locking a slider of a zipper in a closed state, which is applied to a bag-or-the-like (bags) having a zipper.

### BACKGROUND ART

In the case of conventional commercially available bags, when a lock system is used for locking the opening/closing part, a key lock or a dial lock is provided on the surface outside the bags. However, such a configuration is not adopted for high-designed bags because it tends to impair the design. In addition, when a wallet is put in bags with a key lock or a dial lock, it is a cumbersome and annoying task to unlock and open, or close and lock, the bags, at the time taking out the wallet therefrom for eating, drinking or shopping. Also, if the key is lost or the password-number is forgotten, the lock system must be broken, and therefore such a lock system may not be used to avoid such a trouble. Also, in the case of shoulder bags and rucksacks without a lock, there is a risk of fraud and theft of personal information such as driving license, business information, and valuables, and also such a bag or rucksack in crowds can be attacked easily by extraction of valuables therefrom. There is also a risk, in general on the train etc., of misplacement or thief of the bags.

In bags with a zipper, in particular, there is known a zipper lock of bags that comprises a locking member provided on the outside of the bags and a receiving member, to be engaged with the locking member, provided on the inside of the bags used for locking a slider of the zipper in its closed state (for example, Patent document 1).

Also, a storage system is known that comprises a lock means for electrically locking a storage bag, and a control means for unlocking the lock means when an information, received via a communication unit, matches a password number (for example, Patent document 2).

### PRIOR ART DOCUMENTS PATENT DOCUMENTS

Patent document 1: JP 2000-320215 A

Patent document 2: JP HEI 7-293075

### DISCLOSURE OF THE INVENTION

Concerning the zipper lock described in the above-mentioned patent document 1 using the locking member and the receiving member, the locking member for the zipper lock is exposed on the outside of the bags, and therefore such a zipper lock was unsuitable for use in bags with high design value from the view point of design constraints. Moreover, concerning the storage system described in the above-mentioned patent document 2, the design property for the bags with the zipper is not considered at all.

The present invention is to solve the above-described problems, and the object of the present invention is to provide a zipper lock device that has a function for locking and unlocking the slider of the zipper without exposing the lock mechanism to the appearance of the bags and also has good design and convenience.

The present invention is a zipper lock device for locking a slider of a zipper provided on an opening edge of bags, and comprises:

a protrusion provided on a back side of the slider; and

a lock unit provided inside the bags at a forward position of a closing direction of the zipper, for receiving the protrusion so as to lock the slider; wherein

the lock unit comprises:

a lock mechanism for locking the slider by engaging with the protrusion and unlocking the slider by releasing the engaging with the protrusion;

a drive unit for operating the lock mechanism;

an electronic circuit for receiving a wireless signal from a mobile terminal outside the bags and controlling the operation of the drive unit; and

a electric power supply unit for supplying electric power to the drive unit and the electronic circuit,

the electronic circuit comprises:

a communication module for wirelessly communicating with the mobile terminal outside the bags; and

a microcomputer that operates depending on a communication result of the communication module, wherein

when the microcomputer receives a lock signal sent from the mobile terminal via the communication module, the microcomputer operates the lock mechanism by operating the drive unit.

According to the present invention, since the slider of the zipper can be locked inside the bags by remote control using a mobile terminal, and therefore the lock mechanism is not exposed to the exterior of the bags, and the design and convenience is improved. In addition, since the lock unit is provided inside the bags at a forward position of a closing direction of the zipper, it can be easily retrofitted, and also a hidden unlock button, as needed, can be provided at a position difficult to see easily from the exterior of the bags.

### BRIEF DESCRIPTION OF THE DRAWINGS

FIG. 1 is a perspective view of bags provided with a zipper lock device according to an embodiment of the present invention.

FIG. 2 is a block configuration of the zipper lock device.

FIG. 3 is a schematic view showing a state before a slider of a zipper is received by a lock unit, when the zipper lock device is viewed from the inside of the bags.

FIG. 4 is a schematic diagram showing a state after the slider of the zipper is received by the lock unit.

FIG. 5A is a perspective view seen from the back side of the slider of the zipper, and FIG. 5B is a side view of the slider.

FIG. 6 is a perspective view of the lock unit of the zipper lock device as seen from the outside of the bags.

FIG. 7 is a schematic diagram of the zipper lock device for the case having a double slider.

FIG. 8 is a schematic view of the zipper lock device according to a modified example of the above.

FIG. 9 is a view showing an example of a lock mechanism of the zipper lock device for the case having a single slider.

FIG. 10 is a view showing an example of the lock mechanism of the zipper lock device for the case having a double slider.

FIG. 11 is a view showing another example of the lock mechanism of the zipper lock device for the case having a single slider.

FIG. 12 is a view showing still another example of the lock mechanism of the zipper lock device for the case having a double slider.

FIG. 13 is a view showing still another example of the lock mechanism of the zipper lock device.

### MODE FOR CARRYING OUT THE INVENTION

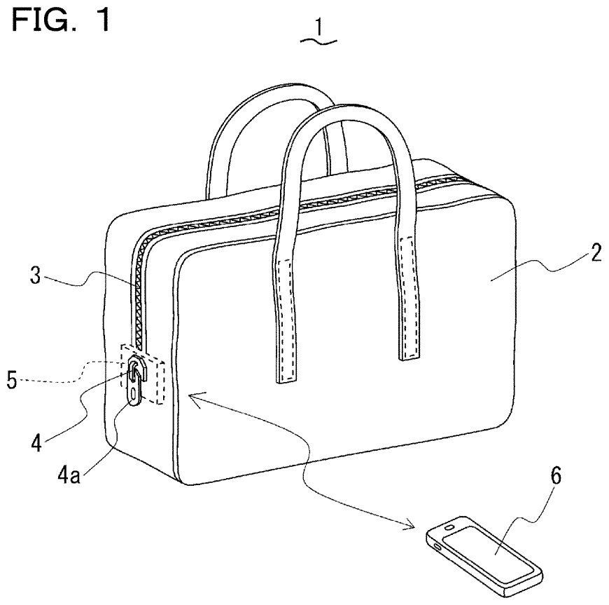

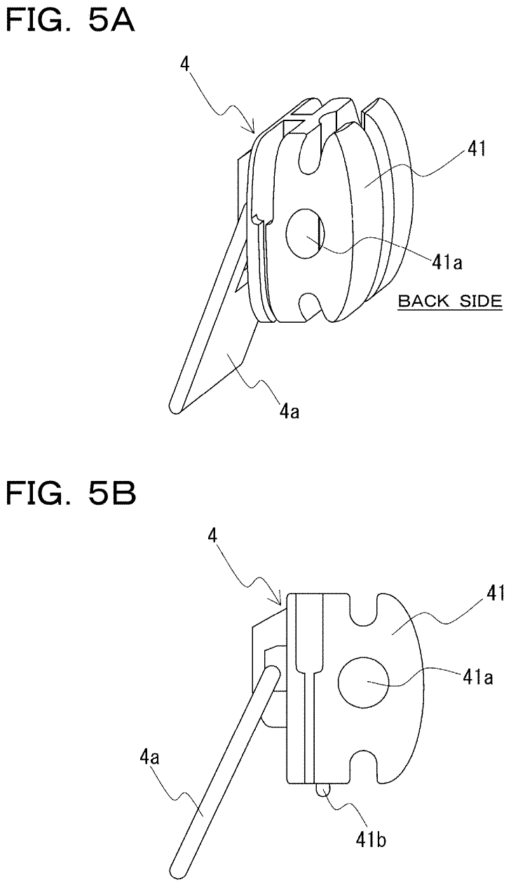

Hereinafter, a zipper lock device according to an embodiment of the present invention is described with reference to FIGS. 1 to 6. FIG. 1 shows the zipper lock device 1 for bags according to the present embodiment. The zipper lock device 1 locks (secures) the slider 4 of the zipper 3 provided on an opening edge of the bags 2. The zipper lock device 1 comprises the protrusion 41 (see FIG. 5) provided on the back side of the slider 4 and the lock unit 5 having a lock mechanism for locking the protrusion 41. The lock unit 5 is attached to the inside surface of the bags 2 at a forward position of a closing direction of the zipper 3 by an appropriate means, and receives the protrusion 41 of the zipper 3 to lock the zipper 3. Since the lock unit 5 as a lock mechanism is not exposed to the appearance of the bags 2, the design and convenience are good. The lock unit 5 operates by receiving a wireless signal from the mobile terminal 6 such as a smart phone or a personal computer from outside the bags 2. For wireless communication, for example, communication means such as Wi-Fi, Bluetooth (registered trademark) is used.

The bags 2 includes various handbags or shoulder bags, an attache case, a rucksack, a suitcase, a storage case, and the like having the zipper 3 at the opening. The zipper 3 includes tapes, teeth as meshing elements fixed to the tapes, the slider 4 for opening and closing the meshing or engaging between the teeth, and the puller 4a for operating the slider 4 handled by a user.

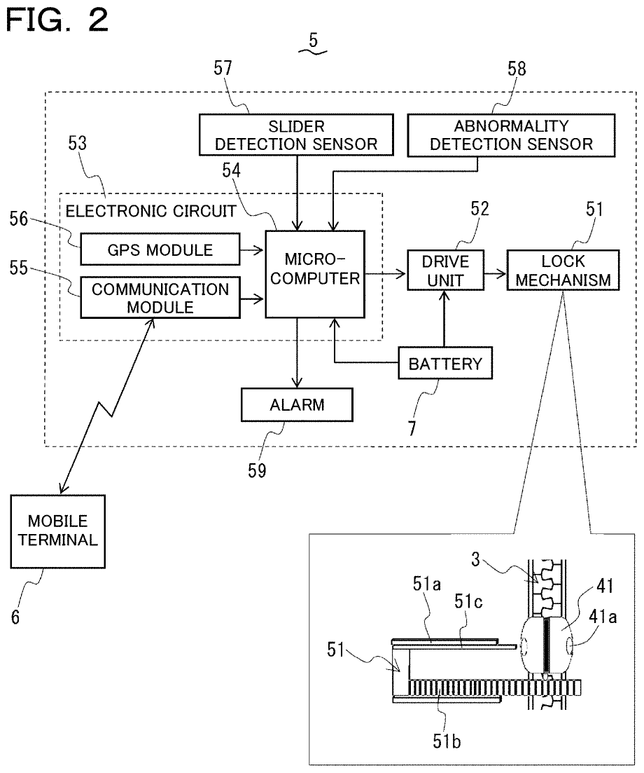

FIG. 2 shows a block configuration of the lock unit 5 of the zipper lock device 1. The lock unit 5 comprises the lock mechanism 51 for locking and unlocking the slider 4, the drive unit 52 for operating the lock mechanism 51, the electronic circuit 53 for controlling the operation of the drive unit 52 by receiving a wireless signal from outside of the bags 2, and the battery 7 which is a electric power supply unit for supplying electric power to the drive unit 52 and the electronic circuit 53. The lock unit 51 locks the slider 4 by engaging with the protrusion 41 of the slider 4 and unlocks the slider 4 by releasing the engaging with the protrusion 41. The electronic circuit 53 comprises the communication module 55 for wirelessly communicating with the mobile terminal 6 outside the bags 2, and the microcomputer 54 that operates depending on a communication result of the communication module 55.

When the microcomputer 54 receives a lock or unlock signal sent from the mobile terminal 6 via the communication module 55, the microcomputer 54 can operate the lock mechanism 51 by operating the drive unit 52 so as to lock or unlock the zipper 3, that is, the slider 4. Also, when the microcomputer 54 judges that the distance between the bags 2 and the mobile terminal 6 is a predetermined distance or more, the microcomputer 54 operates the drive unit 52 to lock the slider 4 by the lock mechanism 51, or sends a warning signal to the mobile terminal 6 via the communication module 55. Note that an application for using the zipper lock device 1 is downloaded to the mobile terminal 6 in advance via a network, and an individual ID address, a password, etc. for communicating with the microcomputer 54 are set in advance.

In this embodiment, the lock unit 5 further comprises the GPS module 56 for position detection, the slider detection sensor 57, the abnormality detection sensor 58, and the alarm 59 such as a buzzer. The GPS module 56 is a module for detecting the position of the bags 2. The slider detection sensor 57 detects that the slider 4 has been inserted into a predetermined position in the lock unit 5. The abnormality detection sensor 58 is formed of, for example, a pressure sensor, and detects a predetermined or more stress applied to the slider 4 in the opening direction when the slider 4 is in a locked state. The alarm 59 notifies to the outside of the bags 2 that the bags 2 is in an abnormal state. The microcomputer 54 operates the drive unit 52, the alarm 59, and the like, based on the signals from the various modules 55 and 56 and the detection signals from the detection sensors 57 and 58.

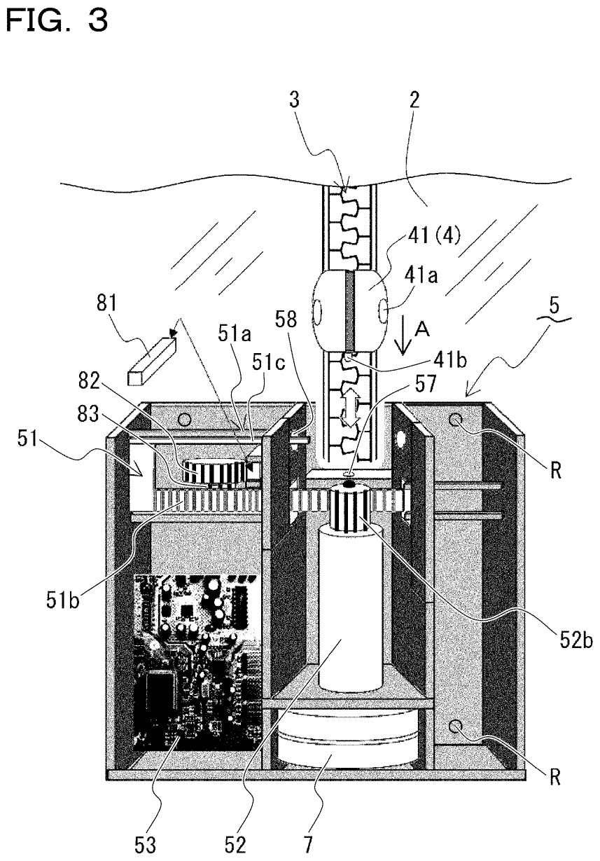

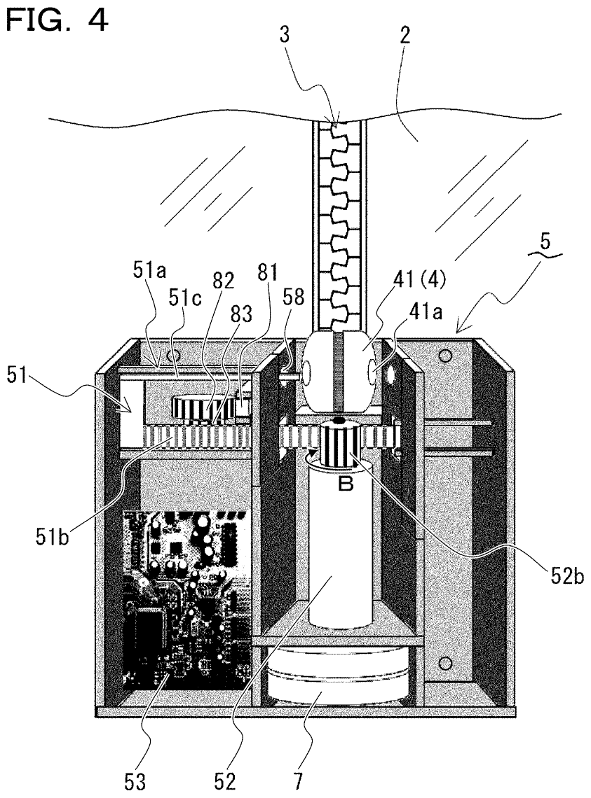

FIG. 3 and FIG. 4 show a specific configuration of the lock unit 5 attached to the inside surface of the bags 2 as viewed from the inside of the bags 2. FIG. 3 shows a state before the protrusion 41 of the slider 4 of the zipper 3 is received by the lock unit 5, and FIG. 4 shows a state immediately before the locking after the protrusion 41 of the slider 4 of the zipper 3 is received by the lock unit 5. FIG. 5A and FIG. 5B show the configuration of the slider 4. The protrusion 41 of the slider 4 comprises the key hole 41a oriented in a direction perpendicular to the moving direction of the slider 4, and in this embodiment, the slider 4 comprises the convex portion 41b at the end of its closing direction. The shape of the key hole 41a is arbitrary, and for example, the length may be 7 mm and the hole diameter may be about 3 mm. The convex portion 41b is provided so as to detect that the slider 4 has been received by the lock unit 5.

The lock unit 5 has a housing made of, for example, a resin exterior case, and is attached by a rivet R or the like on the inside surface of the bags 2 at a forward position of the closing direction of the zipper 3. The shape of the housing is arbitrary, and for example, the vertical dimension is 30 mm, the horizontal dimension is 40 mm, and the depth dimension is about 10 mm. The lock mechanism 51, the drive unit 52, the electronic circuit 53, the slider detection sensor 57, the abnormality detection sensor 58, and the battery 7 are housed inside the housing of the lock unit 5. The alarm 59 may be mounted on the electronic circuit 53. The lock mechanism 51 includes the lock lever 51c, the slide rack 51b integrated with the lock lever 51c, and the guide rail 51a for guiding the lock lever 51c. The lock lever 51c is made of steel or the like, and is driven by the drive unit 52, when the slider 4 is locked, and inserted into the key hole 41a of the protrusion 41 to lock the slider 4. The drive unit 52 is, for example a motor having a pinion gear 52b on its drive shaft, wherein the pinion gear 52b is screwed to the slide rack 51b, and thus, the drive unit 52 slide-drives the slide rack 51b by forward and backward rotation of the pinion gear 52b. The guide rail 51a may be configured by protrusions or a wall-like member provided integrally with the housing of the lock unit 5. The output of rotation by the drive unit 52 is transmitted to the pinion gear 52b via a reduction gear, so that the drive unit 52 may be of low power.

The operation of the zipper lock device 1 configured as the above is described. As shown in FIG. 3, in a state where the protrusion 41 of the slider 4 of the zipper 3 is not received by the lock unit 5, the lock mechanism 51 (lock lever 51c) is located on the left side position and is in an unlocked state. When the user closes the zipper 3, the protrusion 41 of the slider 4 is moved in the closing direction (arrow A in FIG. 3), and the protrusion 41 is received at a predetermined position in the lock unit 5 as shown in FIG. 4, the slider detection sensor 57 detects the convex portion 41b of the slider 4, and then the microcomputer 54 in the electronic circuit 53 recognizes thereby that the slider 4 is in a state possible to be locked. In this state and also under a condition that communication is possible between the mobile terminal 6 possessed by the user and the lock unit 5, when the user operates the mobile terminal 6 to send a lock signal, the microcomputer 54 receives the lock signal transmitted from the mobile terminal 6 via the communication module 55. Then, the microcomputer 54 operates the drive unit 52, rotates the pinion gear 52b in the direction of arrow B as shown in FIG. 4, and moves the lock mechanism 51 to the right. As a result, the lock lever 51c is inserted into the key hole 41a of the protrusion 41 of the slider 4, and the slider 4, that is, the zipper 3 is locked.

When unlocking, the user operates the mobile terminal 6 and sends an unlock signal, the microcomputer 54 receives the unlock signal transmitted from the mobile terminal 6 via the communication module 55. Then, the microcomputer 54 operates the drive unit 52 in the reverse manner to rotate the pinion gear 52b, and thus the lock mechanism 51 moves to the left. As a result, the lock lever 51c comes out of the key hole 41a of the protrusion 41 of the slider 4, and the slider 4, that is, the zipper 3 is unlocked.

Thus, according to the zipper lock device 1 of the present embodiment, the user can lock (secure) the zipper 3 of the bags 2 with the lock unit 5 provided inside the bags 2 by remote control using the mobile terminal 6. This means that the lock function can be given to the bags 2 without affecting the appearance design of the bags 2 at all, which can greatly contribute to the freedom of the appearance design of the bags 2 and to the convenience. Further, since the lock unit 5 is provided inside the bags 2, the degree of freedom is great in designing to have a strong lock function. In the configuration in which the lock lever 51c is inserted into the key hole 41a in the direction perpendicular to the opening/closing movement direction of the zipper 3 as in this embodiment, the zipper 3 can be reliably locked with a small and simple configuration.

The microcomputer 54 can recognize the distance between the bags 2 and the mobile terminal 6 via the communication module 55, and the microcomputer 54 judges that the security mode has been reached when the distance between the bags 2 and the mobile terminal is a predetermined distance (for example, 1 m to 3 m) or more, and in that case the microcomputer 54 automatically operates the lock mechanism 51 to lock the slider 4 and, as occasion demands, activates the abnormality alarm 59 or sends a warning signal to the mobile terminal 6 via the communication module 55 as a security mode. Thereby, a situation where the bags 2 is misplaced by a user or carried away by a suspicious person can be prevented. The distance corresponding to the security mode can be arbitrarily set in a plurality of stages. For example, when the distance between the bags 2 and the mobile terminal 6 possessed by the user becomes at the first set distance or more, the bags 2 is automatically locked, and it becomes further and at the second set distance or more, the alarm buzzer sounds on the side of the bags 2 or the user's mobile terminal 6 is notified by automatic notification, so as to prevent the user from misplacing the bags 2 or others from taking away the bags 2. Further, when the bags 2 is lost or stolen, the bags 2 can be easily found and collected by using the tracking function of the GPS module 56.

Furthermore, when a stress predetermined or more is applied to the slider 4 in the opening direction in the locked state of the slider 4, the stress is also transmitted to the lock lever 51c, so the abnormality detection sensor 58 can detect it. When the microcomputer 54 receives the abnormality detection signal, the microcomputer 54 determines that an abnormal state happens such as an illegal action being performed on the bags 2, and operates the alarm 59 for abnormality to issue a warning by voice or the like. At this time, the microcomputer 54 may send a warning signal or an e-mail to the mobile terminal 6 via the communication module 55. The detected information may be recorded on the application system side in date and time.

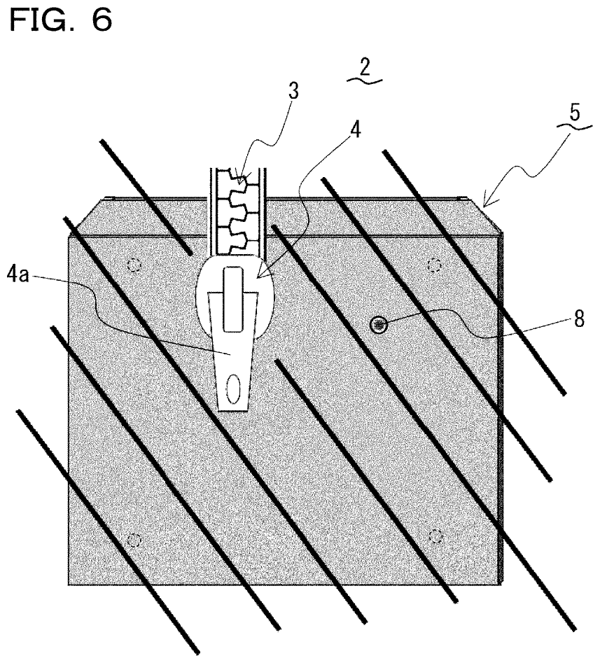

FIG. 6 shows the hidden unlock button 8 used at the time of failure and battery runout, as seen through the lock unit 5 from the outside of the bags 2. The hidden unlock button 8 is used to forcibly unlock the lock mechanism 51 when the lock unit 5 is out of order or when the battery is consumed. The hidden unlock button 8 is provided so that the user can know its position, although it is difficult to visually recognize the hidden unlock button 8 from the appearance of the bags 2. The hidden unlock button 8 is provided on the lock unit 5, the button tip is in contact with the fabric of the bags 2, and the user activates the button by pushing it in several ten mm, for example, from above the fabric of the bags 2, using a thin stick with a pointed tip such as an awl. The hidden unlock button 8 comprises, as shown in FIGS. 3 and 4, the rack 81 integral with the button, the gear 82 meshing with the rack 81, and the release gear 83 integral with the gear 82 that meshes with a rack provided on the rear of the slide rack 51b.

When the hidden unlock button 8 is pushed in, the rack 81 slides and rotates both the gear 82 and the release gear 83 to move the slide rack 51b in the unlock direction. As a result, the lock lever 51c in the locking state comes out of the key hole 41a of the protrusion 41 of the slider 4 and the unlocking is complete. Thus, the unlocking can be accurately performed for the locked state at the time of failure or battery runout. The hidden unlock button 8 is preferably provided, but may be omitted if a highly reliable lock unit 5 is implemented.

In the above embodiment, the lock mechanism 51 is described in the case where the slider 4 of the bags 2 is single, however, the lock mechanism 51 is not limited to the above embodiment, and various modifications are possible, and similarly, various modifications may be made to the lock mechanism in the case where the slider 4 is not single but two or double. These are described below.

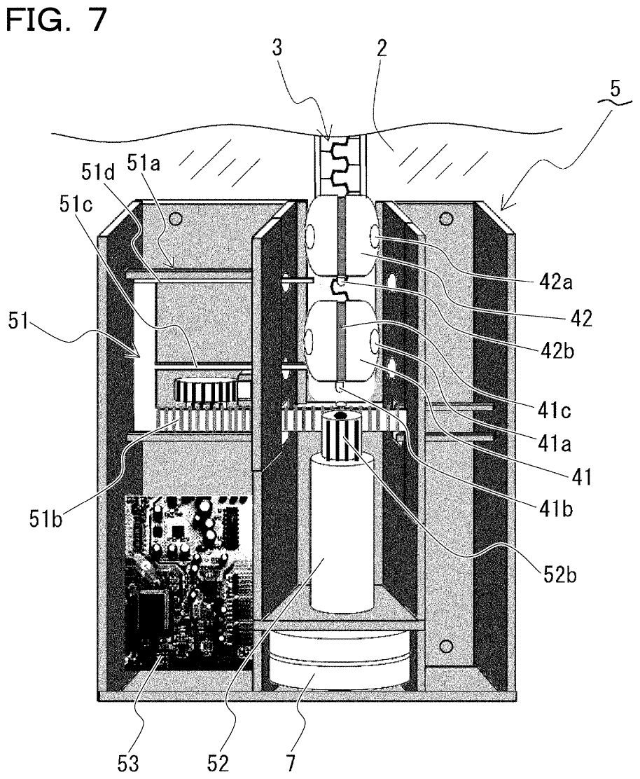

FIG. 7 shows a zipper lock device having a double slider. In this case, the lock mechanism 51 locks both the protrusions 41, 42 provided respectively on the back surfaces of the first and second sliders (4). For this purpose, the lock mechanism 51 includes two lock levers 51c, 51d that are integrally arranged on the slide rack 51b. The lock levers 51c, 51d are respectively inserted into the key holes 41a, 42a of the protrusions 41, 42 of the first and second sliders 4, thereby the double slider is brought into the locked state. Each protrusion 41, 42 has a convex portion 41b, 42b, respectively. In this example, the convex portion 41b is a tip portion of a rod 41c that is slidably inserted into a hole penetrating the protrusion 41 in the vertical direction in the figure. When the second slider is pushed along the closing direction towards the first slider, the convex portion 42b of the protrusion 42 of the second slider pushes the rod 41c provided in the protrusion 41 of the first slider, thereby the convex portion 41b is protruded. When both the double sliders are pushed into a predetermined closing position, the convex portion 41b is detected by the slider detection sensor 57, and they are found in a state possible to be locked. Other configurations are the same as described above. According to this example, the double slider can be reliably locked.

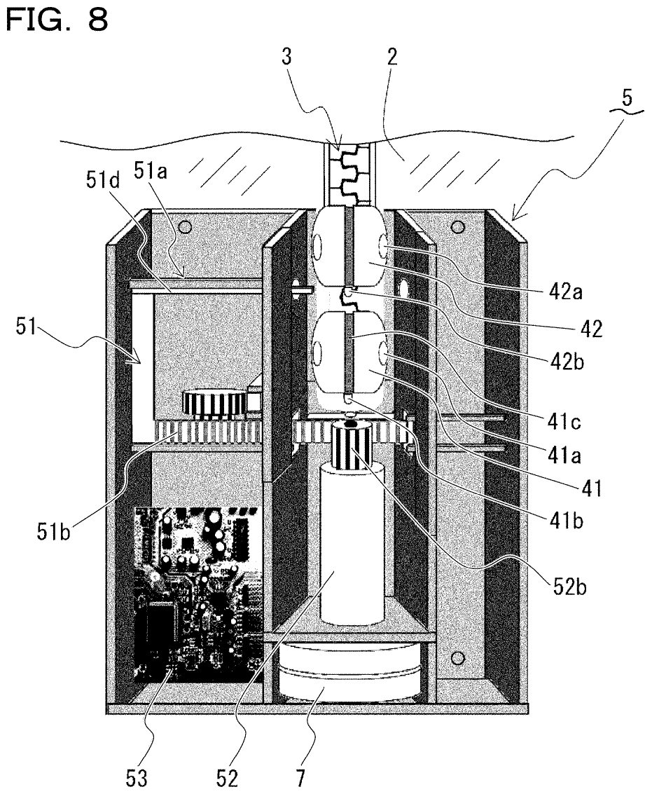

FIG. 8 shows a zipper lock device according to a modification of the above. This is in the case of a double slider, however, the lock mechanism 51 is provided with only one lock lever 51d which is integrally provided with the slide rack 51b. The lock lever 51d is inserted into the key hole 42a of the projection 42 of the second slider, thereby the double slider is brought into the locked state. Other configurations are the same as described above. According to this example, the lock mechanism 51 can have a simple configuration while being a double slider.

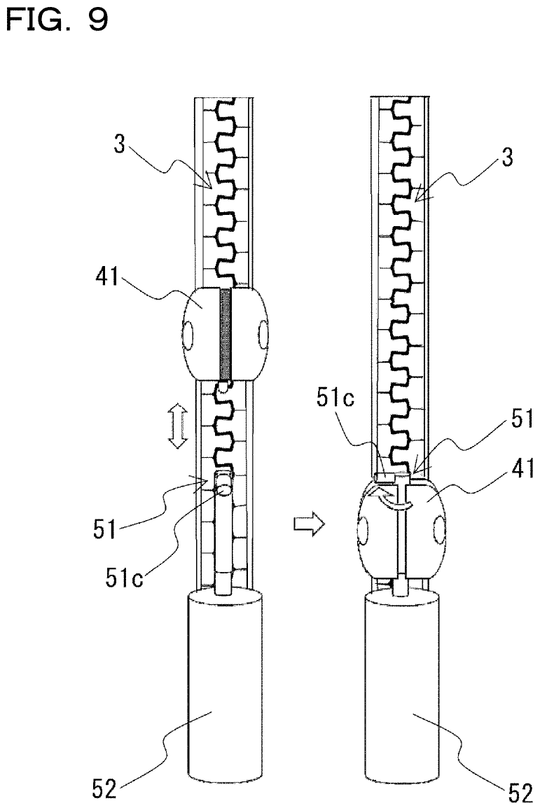

In the lock mechanism 51 in the above-described embodiment, the lock lever 51c is inserted into the key hole 41a laterally provided in the protrusion 41 of the slider. However, the present invention is not limited to this embodiment, and various modifications can be made. FIG. 9 shows a modification of the lock mechanism of the zipper lock device with a single slider. The lock mechanism 51 of this example comprises a lock lever 51c for locking the slider by engaging with the opening direction's end of the protrusion 41 of the slider. The lock lever 51c has a rod rotatable that extends parallel to the open and close moving direction of the slider and a key portion that is bent at the tip thereof. The protrusion 41 of the slider is provided with a longitudinal groove corresponding to a keyhole, in which the rod of the lock lever 51c is received. The locking operation is described, when the protrusion 41 of the slider is moved in the closing direction, from the state shown in the left of FIG. 9 to the state shown in the right of FIG. 9, the rod of the lock lever 51c fits into the longitudinal groove, and when the locking operation is performed in this state, the rod of the lock lever 51c is rotationally driven by the drive unit 52 and the key portion engages with the protrusion 41. According to this modification, the lock lever 51c of the lock mechanism 51 has a simple configuration.

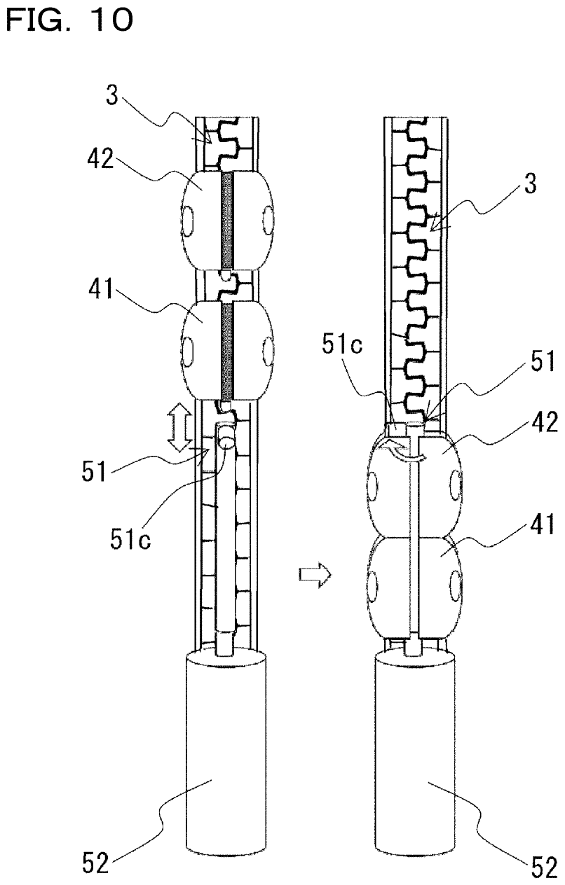

FIG. 10 shows an example of the lock mechanism of the zipper lock device with a double slider. The lock mechanism 51 of this example comprises a lock lever 51c equivalent to the above, and the lock lever 51c locks the double slider by engaging with the opening direction's end of the second slider. As shown in the right of FIG. 10, when the locking operation is performed in the state where the protrusions 41, 42 of the double slider are inserted at predetermined positions, the lock lever 51c is rotated to lock the protrusions 41, 42.

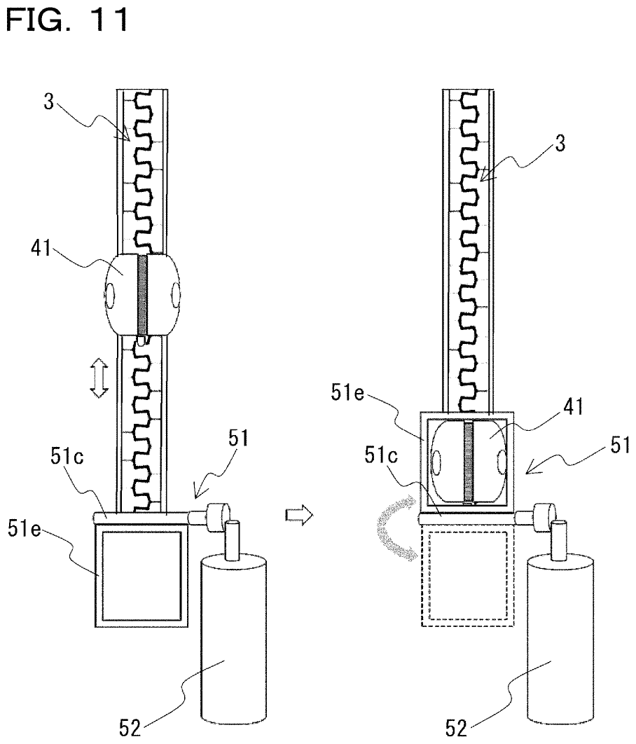

FIG. 11 shows another example of the lock mechanism of the zipper lock device in the case of a single slider. The lock mechanism 51 of this example comprises a lock lever 51c which is a rotation shaft in a direction perpendicular to the open and close moving direction of the slider, and a frame 51e fixed to the lock lever 51c. The lock lever 51c is rotated by the drive unit 52 via a pinion gear and a rotation gear, whereby the frame 51e rotates so as to swing. As shown in the right of FIG. 11, when a locking operation is performed in the state where the protrusion 41 of the slider is inserted at a predetermined position, the frame 51e is rotated and the protrusion 41 is locked.

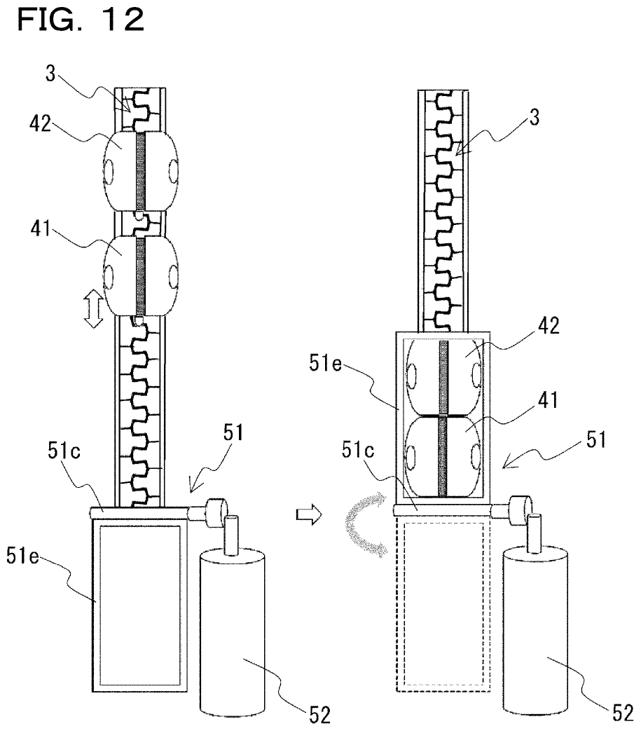

FIG. 12 shows still another example of the lock mechanism of the zipper lock device with a double slider. The lock mechanism 51 of this example comprises a lock lever 51c having the same configuration as described above and a frame 51e, and the frame 51e locks the double slider by engaging with the opening direction's end of the second slider of the double slider. As shown in the right of FIG. 12, when the locking operation is performed in the state where the protrusions 41, 42 of the double slider are inserted at predetermined positions, the frame 51e is rotated and the protrusions 41, 42 are locked.

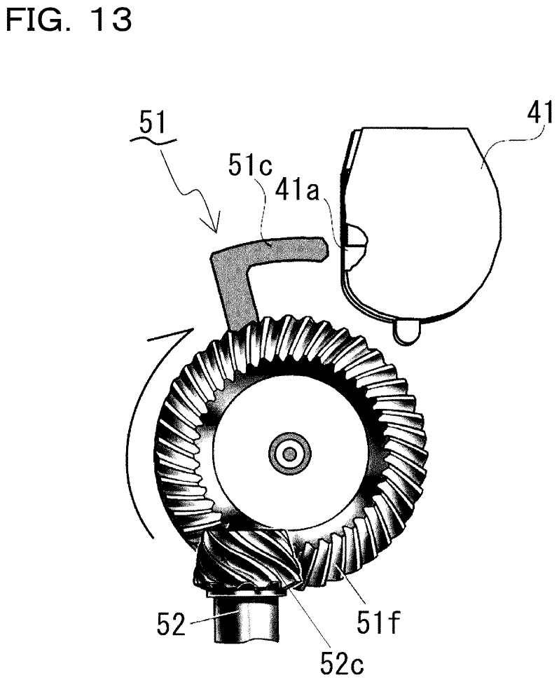

FIG. 13 shows still another example of the lock mechanism of the zipper lock device. The lock mechanism 51 of this example comprises a bevel gear 52c driven by the output of the drive unit 52, a bevel gear 51f meshing with the bevel gear 52c, and a lock lever 51c fixed to the bevel gear 51f. When the bevel gear 51f is rotated clockwise, the lock lever 51c is inserted into the key hole 41a, and thereby the slider 4 (protrusion 41) is locked. When the bevel gear 51f is rotated counterclockwise, the lock lever 51c comes out of the key hole 41a, and the slider 4 (protrusion 41) is unlocked.

In addition, this invention is not limited to the configuration of the said embodiment, and various modifications are possible. For example, the mobile terminal 6 may be a terminal dedicated to this device, and the lock unit 5 may be retrofitted to the bags 2. The drive unit 52 is not limited to a motor, and a drive mechanism such as a plunger may be used. In addition, the slider detection sensor 57, the abnormality detection sensor 58, the abnormality notification device 59, and the like are desirably provided, but are not necessarily provided. In addition, if a smartphone is used as the mobile terminal 6 and an access point and the Internet are used for Wi-Fi communication, the position information can be acquired, so that an equivalent action can be obtained without using the GPS module 56. In addition, it may be enabled for the user to send an electronic key to a trusted third-party mobile terminal and unlock using the electronic key, or it may be enabled for only a specific person to use an one-time key to unlock.

This application is based on Japanese Patent Application No. 2017-075484, and the contents thereof should be incorporated into the present invention as a result by referring to the specification and drawings of the above patent application.

### EXPLANATIONS OF LETTERS OR NUMERALS

1 Zipper lock device

2 Bags

3 Zipper

4 Slider

41, 42 Protrusion

41a, 42a Keyhole

41b, 42b Convex portion

41c Rod

5 Lock unit

51 Lock mechanism

51a Guide rail

51b Slide rack

51c, 51d Lock lever

51e Frame

51f Bevel gear

52 Drive unit

52b Pinion gear

52c Bevel gear

53 Electronic circuit

54 Microcomputer

55 Communication module

56 GPS module

57 Slider detection sensor

58 Abnormality detection sensor

59 Alarm

6 Mobile terminal

7 Battery (power supply)

8 Hidden unlock button

81 Rack

82 Gear

83 Release gear

1. A zipper lock device for locking a slider of a zipper provided on an opening edge of bags, comprising:
a protrusion provided on a back side of the slider; and
a lock unit provided inside the bags at a forward position of a closing direction of the zipper, for receiving the protrusion so as to lock the slider; wherein
the lock unit comprises:
a lock mechanism for locking the slider by engaging with the protrusion and unlocking the slider by releasing the engaging with the protrusion;
a drive unit for operating the lock mechanism;
an electronic circuit for receiving a wireless signal from a mobile terminal outside the bags and controlling the operation of the drive unit; and
a electric power supply unit for supplying electric power to the drive unit and the electronic circuit,
the electronic circuit comprises:
a communication module for wirelessly communicating with the mobile terminal outside the bags; and
a microcomputer that operates depending on a communication result of the communication module, wherein
when the microcomputer receives a lock or unlock signal sent from the mobile terminal via the communication module, the microcomputer operates the lock mechanism by operating the drive unit.

2. The zipper lock device according to claim 1, wherein when the microcomputer judges that a distance between the bags and the mobile terminal is a predetermined distance or more, the microcomputer operates the drive unit to lock the slider using the lock mechanism or sends a warning signal to the mobile terminal via the communication module.

3. The zipper lock device according to claim 2, wherein
the lock unit comprises: a sensor for detecting a stress, applied to the slider, in an opening direction of the zipper; and an alarm for notifying to the outside of the bags that the bags is in an abnormal state, and
the microcomputer activates the alarm when the microcomputer judges, based on the a detected signal by the sensor, that the bags is in an abnormal state.

4. The zipper lock device according to claim 1, wherein
the slider comprises a keyhole on the protrusion in a direction perpendicular to the moving direction of the slider,
the lock mechanism comprises a lock lever that is driven and inserted into the keyhole by the drive unit when the slider is locked, and a guide rail that guides the lock lever.

5. The zipper lock device according to claim 2, wherein
the slider comprises a keyhole on the protrusion in a direction perpendicular to the moving direction of the slider,
the lock mechanism comprises a lock lever that is driven and inserted into the keyhole by the drive unit when the slider is locked, and a guide rail that guides the lock lever.

6. The zipper lock device according to claim 3, wherein
the slider comprises a keyhole on the protrusion in a direction perpendicular to the moving direction of the slider,
the lock mechanism comprises a lock lever that is driven and inserted into the keyhole by the drive unit when the slider is locked, and a guide rail that guides the lock lever.
